(19) United States
(12) Patent Application Publication
(10) Pub. No.: US 2009/0167635 A1
(43) Pub. Date: Jul. 2, 2009

(54) DEVICE, SYSTEM, AND METHOD OF APPENDING A DISPLAY OF A MOBILE DEVICE

(76) Inventors: Roy Want, Los Altos, CA (US); Trevor A. Pering, Palo Alto, CA (US)

Correspondence Address: Shiloh et al., C/O INTELLEVATE , LLC, P.O BOX 52050, MINNEAPOLIS, MN, 55402, US

(21) Appl. No.: 11/967,203

(22) Filed: Dec. 30, 2007

(51) Int. Cl. G09G 5/00

(52) U.S. Cl. 345/2.2

(57) ABSTRACT

Device, system, and method of appending a display of at least one mobile device. In some demonstrative embodiments, a mobile device may include a display; a wireless communication module to establish one or more wireless communication links with one or more or more other mobile devices having one or more other displays, respectively; a frame buffer having a first area allocated to buffer information to be displayed on the display; a frame buffer allocator to dynamically expand the frame buffer to include one or more additional areas allocated to buffer information to be displayed on the one or more other displays, respectively; and one or more remote-frame-buffer protocols to transfer the information from the one or more additional areas to the one or more mobile devices, respectively. Other embodiments are described and claimed.

### BACKGROUND

A mobile device may include a display having a relatively fixed display area, which may not be big enough to allow convenient viewing of relatively large images, e.g., a large architectural blueprint, or a spreadsheet having a large number of rows and/or columns.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments; and

FIG. 2 is a schematic flow-chart illustration of a method of appending a display of at least one mobile device, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein include, for example, “multiple” or “two or more”. For example, “a plurality of items” includes two or more items.

Although portions of the discussion herein relate, for demonstrative purposes, to wired links and/or wired communications, embodiments of the invention are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11g, 802.11n, 802.16, 802.16d, 802.16e, 802.20, 802.21 standards and/or future versions and/or derivatives of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth (RTM), Global Positioning System (GPS), Wi-Fi, Wi-Max, ZigBee™, Ultra-Wideband (UWB), Global System for Mobile communication (GSM), 2G, 2.5G, 3G, 3.5G, Enhanced Data rates for GSM Evolution (EDGE), or the like. Other embodiments may be used in various other devices, systems and/or networks.

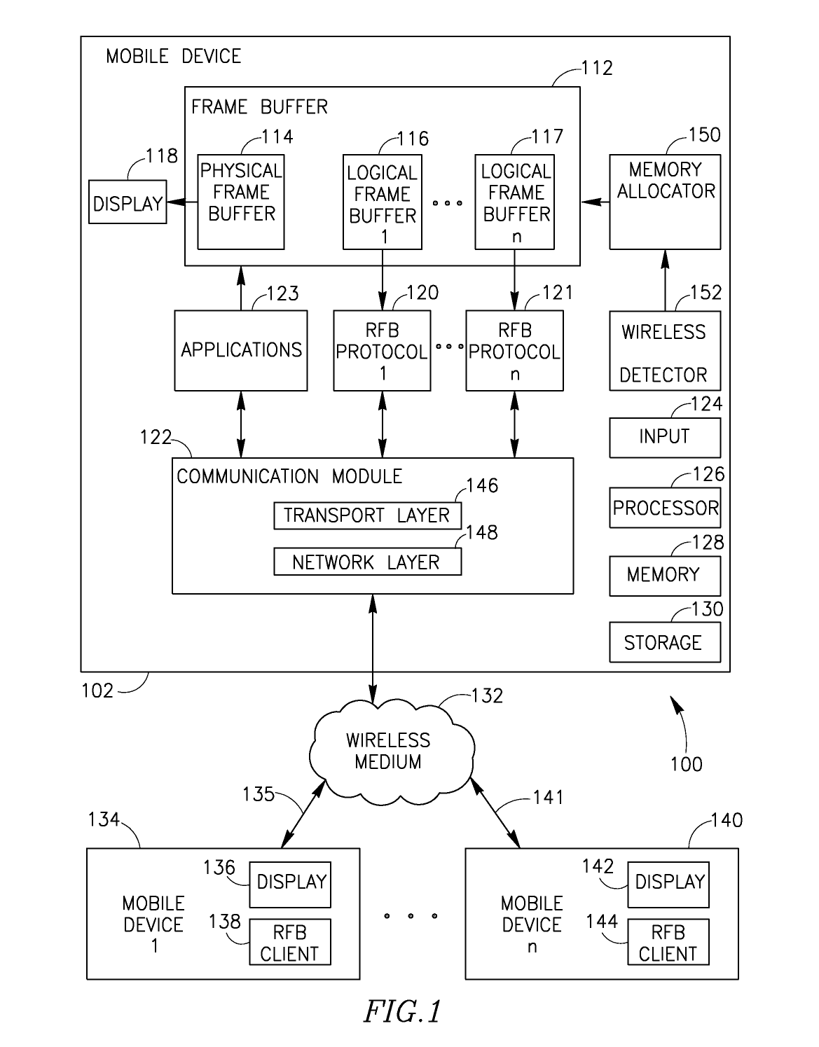

Reference is made to FIG. 1, which schematically illustrates a block diagram of a system 100 in accordance with some demonstrative embodiments.

In some demonstrative embodiments, system 100 may include a mobile device 102 having an integral display 118 (“the internal display”), e.g., a screen integrated within the housing or body of mobile device 102. Display 118 may have a predefined display area.

There may be occasions when a user of device 102 would like to display images requiring a display area larger than the display area of display 118, e.g., a display area, which is double, or triple the display area of display 118. For example, the user may like to view a relatively large architectural blueprint, to sort photographs, to open a spreadsheet with many columns and/or rows which are to be viewed simultaneously, and the like.

In some demonstrative embodiments, mobile device 102 may be capable of dynamically appending one or more displays of one or more other mobile devices to artificially create and/or simulate a combined display area, which is larger than the display area of display 118, e.g., as described in detail below.

In some demonstrative embodiments, mobile device 102 may be capable of communicating with one or more other mobile devices via a wireless communication medium 132. For example, mobile device 102 may communicate with n≧1 mobile devices, e.g., including mobile devices 134 and/or 140. Wireless communication medium 132 may include any suitable wireless communication link and/or connection, for example, a local wireless-connection, e.g., an IEEE 802.11 communication link, an IEEE 802.16 communication link, a Bluetooth communication link, an UWB communication link, or the like.

Mobile devices 102, 134 and/or 140 include, for example, a laptop computer, a notebook computer, a tablet computer, a PDA device, a cellular phone, a mobile phone, a hybrid device, e.g., combining cellular phone functionalities with PDA device functionalities, a relatively small computing device, a “smart-phone”, a non-desktop computer, a portable device, a handheld device, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, or the like.

Mobile device 102 includes, for example, a processor 126; an internal memory 128, e.g., a Random Access Memory (RAM); an internal storage 130, e.g., a hard disk drive; an integrated input unit 124, e.g., a keyboard and/or a touch-pad integrated within a housing or body of mobile device 102; a wireless communication module 122, e.g., including one or more transceivers and/or antennas, capable of communicating with mobile devices 134 and/or 140 over wireless medium 132. In some demonstrative embodiments, communication module 122 may include a short range high-bandwidth communication module, e.g., a UWB communication module. In other embodiments, communication module 122 may include any other suitable wireless communication module. Communication module 122 may include for example, at least a suitable transport layer 146, and/or a suitable network layer 148. In one example, wireless communication module 122 may establish one or more wireless communication links with the one or more other mobile devices, e.g., mobile device 102 may establish communication links 135 and/or 141 with mobile devices 134 and/or 140, respectively.

In some demonstrative embodiments, mobile devices 134 and/or 140 may include integrated displays 136 and/or 142, respectively (“the other displays”).

In some demonstrative embodiments, mobile device 102 may also include one or more applications 123 to generate display information to be displayed on display 118 and at least one of displays 136 and 142, e.g., as described herein. The applications 123 may include, for example, any suitable User Interface (UI) application to render a UI.

In some demonstrative embodiments, applications 123 may include a UI application adapted to render a UI on a display area larger than a display area of display 118. For example, the UI may require a resolution, graphic configuration, font size, icon size, and/or any other suitable parameter corresponding to a display area larger than the display area of display 118. For example, the UI may include a spreadsheet, e.g., an Excel spread sheet, having a relatively large number of columns and/or rows; an image-editing and/or graphics creation application, e.g., a Photoshop application, requiring a resolution and/or graphic configuration corresponding to a display area larger than the display area of display 118; an architectural application capable of displaying an architectural program and/or blueprint; and/or any other suitable application.

In some demonstrative embodiments, applications 123 may be implemented by any suitable one or more elements or components of mobile device 102. For example, memory 128 and/or storage 130 may store one or more sets of application instructions, which when executed by processor 126 may result in applications 123.

In some demonstrative embodiments, mobile device 102 may also include a frame buffer 112 to buffer the display information generated by applications 123. Frame buffer 112 may have a first area 114 (“the physical frame buffer”) allocated to buffer display information of an image to be displayed on display 118. Frame buffer 112 may be implemented as part of any suitable element of mobile device 102. In one example, at least part of frame buffer 112 may be implemented as a “real” or “physical” frame buffer memory, e.g., as part of memory 128. In another example, at least part of frame buffer 112 may be implemented as a “logical” or “virtual” frame buffer, which may include, for example, state information, e.g., size, and/or window location, representing a display.

In some demonstrative embodiments, mobile device 102 may also include a frame buffer allocator 150 to dynamically expand frame buffer 112 to include one or more additional frame buffer areas (“the logical frame buffers”) of frame buffer 112 allocated to buffer information to be displayed on the one or more other displays, respectively, e.g., as described below.

In some demonstrative embodiments, allocator 150 may expand frame buffer 112 based on at least one criterion corresponding to the one or more other displays. In one example, the criterion may be related to a number of the other displays, e.g., as described below.

In some demonstrative embodiments, allocator 150 may dynamically expand frame buffer 112, based for example, on the number of the other mobile devices. For example, allocator 150 may dynamically expand frame buffer 112 to include one or more logical frame buffers to buffer information for one or more mobile devices, which are detected by mobile device 102.

In some demonstrative embodiments, allocator 150 expand frame buffer 112 to include n logical frame buffers to buffer display information to be displayed on the displays of the n other mobile devices, respectively. In one example, allocator 150 may allocate a logical frame buffer 116 to buffer display information to be displayed on display 136; and/or a logical frame buffer 117 to buffer display information to be displayed on display 140. For example, applications 123 may render into physical frame buffer 114 information corresponding to an image to be displayed on display 118, to render into logical frame buffer 116 information corresponding to an image to be displayed on display 136, and to render into logical frame buffer 117 information corresponding to an image to be displayed on display 142.

In some demonstrative embodiments, the criterion may be related to a display area of the one or more other displays. For example, allocator 150 may expand frame buffer 112 to include logical frame buffers 116 and 117 based on a display area of displays 136 and 142, respectively. For example, an area or size of logical frame buffer 116 may be smaller than an area or size of logical frame buffer 117, e.g., if a display area of display 136 is smaller than a display are of display 142.

In some demonstrative embodiments, physical frame buffer 114 may buffer display information rendering a portion of an extended image. The extended image may have, for example, a display area equal to or smaller than the sum of the display areas of display 108 and the n other displays. For example, the display area of the extended image may be equal to the sum of the display areas of displays 118, 136, and 142. The n logical frame buffers may buffer display information rendering one or more other respective portions of the extended image. For example, logical frame buffers 116 and 117 may buffer information rendering two respective portions of the extended image. In one example, buffers 114, 116, and 117 may buffer display information rendering three contiguous portions of the extended image.

In some demonstrative embodiments, mobile device 102 may include a wireless detector 152 to detect one or more mobile devices, e.g., devices 134 and/or 140, which may be connected to device 102 via wireless medium 132.

In some demonstrative embodiments, upon detecting a mobile device by module 152 (“the detected device”), detector 152 may cause mobile device 102 to establish a wireless communication link with the detected device. Detector 152 may cause allocator 150 to expand frame buffer 112 to include a logical frame buffer intended to buffer information to be displayed by the detected mobile device. For example, upon detecting devices 134 and/or 140, mobile device 102 may establish links 135 and/or 141, respectively, and detector 152 may cause allocator 150 to expand frame buffer 112, and to allocate logical frame buffers 116 and/or 117.

In some demonstrative embodiments, mobile device 102 may also include one or more Remote-Frame-Buffer (RFB) protocols to transfer the information from the one or more logical frame buffers to the one or more mobile devices, respectively. For example, mobile device may include n RFB protocols to transfer the information from the n logical frame buffers to the n other mobile devices, respectively. In one example, mobile device 102 may include a RFB protocol 120 to transfer the information of logical frame buffer 116 to mobile device 134, e.g., via link 135; and a RFB protocol 121 to transfer the information of logical frame buffer 117 to mobile device 140, e.g., via link 141. RFB protocols 120 and 121 may include any suitable application, program and/or protocol. For example, RFB protocols 120 and/or 121 may include a Virtual Network Computing (VNC) application.

In some demonstrative embodiments, RFB protocols 120 and 121 may include RFB server protocols, e.g., VNC server protocols, capable of monitoring logical frame buffers 116 and 117, respectively, to detect a change in the display information buffered by logical frame buffers 116 and 117; and, upon detecting a change in the buffered information, to transfer the buffered information, e.g., in a compressed format, to mobile devices 134 and 140, respectively, e.g., via wireless medium 132. Mobile device 134 may include a RFB client protocol 138, e.g., a suitable VNC client protocol, capable of updating an image displayed by display 136, e.g., based on the buffered information received from RFB protocol 120. Mobile device 140 may include a RFB client protocol 144, e.g., a suitable VNC client protocol, capable of updating an image displayed by display 142, e.g., based on the buffered information received from RFB protocol 120.

In some demonstrative embodiments, the images displayed by displays 118, 136 and 142 may be contiguous, e.g., since frame buffers 114, 116, and 117 may include contiguous areas of frame buffer 112. Accordingly, displays 118, 136 and 142 may appear to show an extended display area, e.g., if mobile devices 102, 134 and 140 are placed next to each other in the same relative position as frame buffers 114, 116 and 117.

In some demonstrative embodiments, mobile device 102 may inform the user that mobile devices 134 and/or 140 are available for connection, e.g., upon detector 152 detecting mobile devices 134 and/or 140. For example, mobile device 102 may display one or more predefined icons, e.g., as part of a taskbar, which may be displayed to the user by display 108. Upon receiving an instruction from the user to establish the connection, e.g., when the user clicks on and/or selects one of the icons, communication module 122 may establish links 135 and/or 141; allocator 150 may dynamically expand frame buffer 112; and RFB protocols 120 and 121 may be activated.

In some demonstrative embodiments, mobile device 102 may implement at least one frame-buffering scheme, e.g., as are described below.

According to a first frame-buffering scheme, mobile device 102 may identically copy frame buffer 112 onto each of mobile devices 134 and 140.

According to a second frame-buffering scheme, mobile device 102 may double the size of frame buffer 112 such that each of mobile devices 134 and 140 is allocated with one half of frame buffer 112.

According to a third frame-buffering scheme, mobile device 102 may stretch frame buffer 112 across mobile devices 134 and 140, e.g., such that a number pixels of the displayed image stays unchanged, while the display area is doubled.

According to a fourth frame-buffering scheme, mobile device 102 may create frame buffers 116 and 117 a separate frame buffers, e.g., a noncontiguous frame buffers.

In some embodiments, mobile device 102 may allow the user of mobile device 102 to select a desired frame-buffering scheme from a plurality of frame-buffering schemes, e.g., including one or more of the four frame-buffering schemes described above. In one example, mobile device 102, may maintain information identifying a previous frame-buffering scheme implemented in conjunction with a previous connection with one or more other mobile devices, and automatically apply the previous frame-buffering scheme, e.g., upon re-connecting to the one or more other mobile devices.

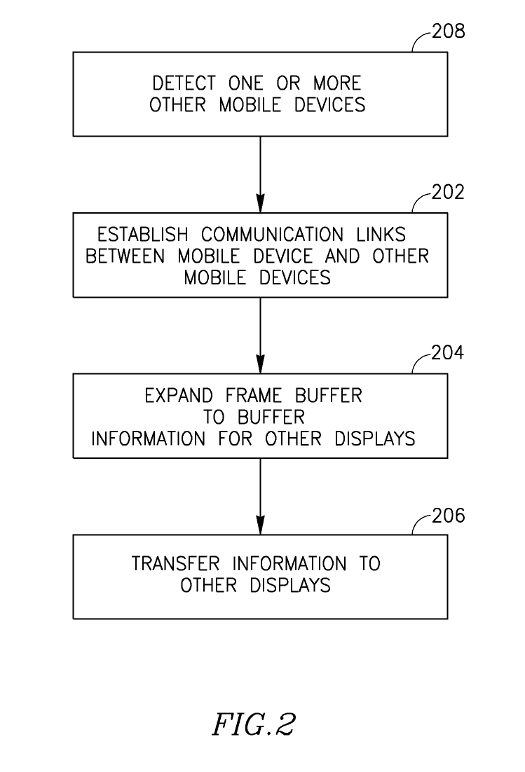

Reference is now made to FIG. 2, which schematically illustrates a method of appending a display of at least one mobile device, in accordance with some demonstrative embodiments. In some non-limiting embodiments, one or more operations of FIGS. 2 may be performed by a mobile device, e.g., mobile device 102 (FIG. 1), to automatically append one or more displays of one or more other mobile devices, e.g., mobile devices 134 and/or 140 (FIG. 1).

As indicated at block 202, the method may include establishing one or more wireless communication links between a mobile device having a display and one or more other mobile devices having one or more other displays, respectively. For example, mobile device 102 (FIG. 1) may establish wireless communication links with one or more detected mobile devices, e.g., devices 134 (FIG. 1) and/or 140 (FIG. 1), as described above. The mobile device may include a frame buffer having a first frame buffer area allocated to buffer information to be displayed on the display. For example, mobile device 102 (FIG. 1) may include frame buffer 112 (FIG. 1), as described above.

As indicated at block 204, the method may include expanding the frame buffer to include one or more additional areas allocated to buffer information to be displayed on the one or more other displays, respectively. For example, allocator 150 (FIG. 1) may dynamically expand frame buffer 112 (FIG. 1) to include logical frame buffers 116 and/or 117 (FIG. 1), e.g., as described above.

In some demonstrative embodiments, expanding the frame buffer may include expanding the frame buffer based on a display area of the one or more other displays. For example, the method may include allocating a first frame buffer area to a first display of the displays, and a second frame buffer area smaller than the first frame buffer area to a second display having a display area smaller than a display area of the first display, e.g., as described above.

In some demonstrative embodiments, expanding the frame buffer may include expanding the frame buffer based on a number of the other displays, e.g., as described above.

As indicated at block 206, the method may also include transferring the information from the one or more additional frame buffer areas to the one or more mobile devices, respectively. For example, RFB protocols 120 and/or 121 (FIG. 1) may transfer the information from buffers 116 and/or 117 (FIG. 1), respectively, to mobile devices 134 and/or 140 (FIG. 1) respectively.

As indicated at block 208, the method may include detecting the other mobile devices, and expanding the frame buffer may include allocating the one or more additional areas of the frame buffer upon the detection of the other mobile devices. For example, detector 152 (FIG. 1) may cause allocator 150 (FIG. 1) to expand frame buffer 112 (FIG. 1), e.g., upon detecting mobile devices 134 and/or 140 (FIG. 1), as described above.

Other operations or sets of operations may be used in accordance with some embodiments.

Some embodiments, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and/or an optical disk. Some demonstrative examples of optical disks include compact disk read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A mobile device comprising:
a display;
a wireless communication module to establish one or more wireless communication links with one or more or more other mobile devices having one or more other displays, respectively;
a frame buffer having a first area allocated to buffer information to be displayed on said display;
a frame buffer allocator to dynamically expand said frame buffer to include one or more additional areas allocated to buffer information to be displayed on said one or more other displays, respectively; and
one or more remote-frame-buffer protocols to transfer the information from said one or more additional areas to said one or more mobile devices, respectively.

2. The mobile device of claim 1, wherein the information to be displayed on said display renders a portion of an extended image having a display area equal to the sum of the areas of said display and said other displays, and wherein the information to be displayed on said one or more other displays render one or more other respective portions of said extended image.

3. The mobile device of claim 1, wherein said frame buffer allocator expands said frame buffer based on a display area of said one or more other displays.

4. The mobile device of claim 3, wherein said frame buffer allocator is to allocate a first frame buffer area to a first display of said displays, and a second frame buffer area smaller than said first frame buffer area to a second display having a display area smaller than a display area of said first display.

5. The mobile device of claim 1, wherein said frame buffer allocator expands said frame buffer based on a number of said other displays.

6. The mobile device of claim 1 comprising a detector capable of detecting said other mobile devices and causing said frame buffer allocator to allocate the one or more additional areas of said frame buffer upon the detection of said other mobile devices.

7. The mobile device of claim 1, wherein said one or more wireless communication links comprise one or more local wireless communication links.

8. The mobile device of claim 1, wherein said mobile device comprises a device selected from the group consisting of: a laptop computer, a notebook computer, a tablet computer, a cellular phone, a handheld device, a wireless communication device, a wireless communication station, and a Personal Digital Assistant device.

9. A method comprising:
establishing one or more wireless communication links between a mobile device having a display and one or more other mobile devices having one or more other displays, respectively, wherein said mobile device includes a frame buffer having a first area allocated to buffer information to be displayed on said display;
expanding said frame buffer to include one or more additional areas allocated to buffer information to be displayed on said one or more other displays, respectively; and
transferring the information from said one or more additional areas to said one or more mobile devices, respectively.

10. The method of claim 9, wherein the information to be displayed on said display renders a portion of an extended image having a display area equal to the sum of the areas of said display and said other displays, and wherein the information to be displayed on said one or more other displays render one or more other respective portions of said extended image.

11. The method of claim 9, wherein said expanding comprises expanding said frame buffer based on a display area of said one or more other displays.

12. The method of claim 11 comprising allocating a first frame buffer area to a first display of said displays, and a second frame buffer area smaller than said first frame buffer area to a second display having a display area smaller than a display area of said first display.

13. The method of claim 9 comprising detecting said other mobile devices, wherein said expanding comprises allocating the one or more additional areas of said frame buffer upon the detection of said other mobile devices.

14. The method of claim 9, wherein said expanding comprises expanding said frame buffer based on a number of said other displays.

15. The method of claim 9, wherein said one or more wireless communication links comprise one or more local wireless communication links.
